(19) United States
(12) Patent Application Publication
(10) Pub. No.: US 2011/0065059 A1
(43) Pub. Date: Mar. 17, 2011

(54) Sealing device for rotating furnace and cooler for calcination of oil coke

(75) Inventors: Genivaldo Linhares Brandão, Santos/Sao Paulo (BR); Manuel Lind Gomes, Santos/Sao Paulo (BR); Valdemir dos Santos Dias, Cubatao/Sao Paulo (BR); Paulo Gonçalves de Oliveira, Sao Vicente/Sao Paulo (BR)

(73) Assignee: PETROCOQUE S/A INDUSTRIA E COMERCIO, Cubatao/Sao Paulo (BR)

(21) Appl. No.: 12/807,986

(22) Filed: Sep. 16, 2010

(30) Foreign Application Priority Data
Sep. 17, 2009 (BR) PI 090.3534-6

(51) Int. Cl. F27B 7/24

(52) U.S. Cl. 432/115

(57) ABSTRACT

A sealing device for a rotating furnace and cooler for calcination of oil coke has lead plates mounted in sliding form on individual supports attached to a flange which constitutes the fixed part of the furnace or cooler. The plates are aligned side by side, forming a collar of coplanar plates encircling the external diameter of the furnace or cooler, forming a self-adjustable sealing curtain between the joint point of its rotating and fixed parts, while the cylindrical body presents a track against which all plates are handled and held with a certain pressure, maintaining the sealing between the rotating and fixed part of the set, both in the furnace and in the cooler.

### CROSS REFERENCE TO RELATED APPLICATION

Applicants claim priority under 35 U.S.C. §119 of Brazilian Application No. PI 090.3534-6 filed Sep. 17, 2009.

### BACKGROUND OF THE INVENTION

More specifically, this Invention relates to technical and functional improvements especially created in a circular sealing device particularly developed to encircle the external diameter of rotating furnaces used for calcination of oil cokes, considering a configuration of a sealing curtain self-adjustable to the external diameter of the referred furnace or cooler, avoiding the entrance of leakage air to the system, which endangers the process parameters control.

Both the furnace and the cooler have cylindrical rotating bodies with fixed heads and, between them, the corresponding cylindrical rotating bodies form points which should be sealed to avoid the entrance of leakage air, which endangers the precise control of the process. Currently, this sealing is defined by a fixed system which encircles the whole external peripherals of the calcinating furnace or cooler, logically on its ends and attached to the joint spot between rotating and fixed parties, where the sealing is obtained with metallic sustaining plates, all of them with oblong holes and means to be moved by traction against the wall of the calcinating furnace.

There is no doubt that the technology of the status of technique presents means to avoid the entrance of leakage air; however, not with the proper efficiency, not only with regards to the accuracy of the functioning, but also in terms of durability, since this is a system with too much friction and consequentially with increased to wear, which requires more maintenance cares and, even thus, some inconveniences happen with final prejudice endangering the sealing between the mobile (rotating) part and the static part of the system, resulting in the entrance of leakage air into the system, requiring even too much maintenance intervention for the sealing adjustment.

### SUMMARY OF THE INVENTION

In light of circumstances above and with the purpose of overcoming them, this invention was created to, in general lines, mean a new sealing concept, defined by a plurality of lead plates, all equal, with ordinarily rectangular shape, all of them mounted in radial form and in coplanar form against the face of a flange or corresponding detail existing both in the rotating furnace and the rotating cooler, and thus all plates are mounted in sliding form, radially falling upon the external diameter of the rotating body, even with a certain pressure established by a pair of springs. Thus, a sealing collar is formed to encircle and be self-adjustable to the diameter of the rotating body, compensating any irregularities of its diameter, including deformations increased by high temperatures, thus composing an efficient sealing system and, at the same time, efficient also with regards to durability, since it combines the lead and a well handled system, ensuring a proper sealing with no increase of friction between fixed and mobile parts, providing significant advantages, especially a better sealing of gaps between the mobile (rotating) and static part of the system, avoiding the entrance of leakage air, allowing for the reduction of maintenance interventions for sealing adjustment and a better process control.

### DESCRIPTION OF DRAWINGS

For a better understanding of this Invention, we provide below a detailed description of its, with reference to the attached drawings:

FIG. 1 is a schematic side view of a calcinating rotating furnace of oil coke;

FIG. 2 shows another schematic view, but of a rotating cooler of oil calcinated coke; and

FIGS. 3 and 4 show several views, detailing the assembly and parts forming this device.

### DETAILED DESCRIPTION OF THE INVENTION

As it is well known to the ones familiar with this technique, the calcinated oil coke is an important input used for the production of primary aluminum, and thus is intended to carry the electric current for the electrolytic reaction of alumina dissociation for the aluminum production. Most of the production of oil calcinated coke in the world is made by rotating furnaces.

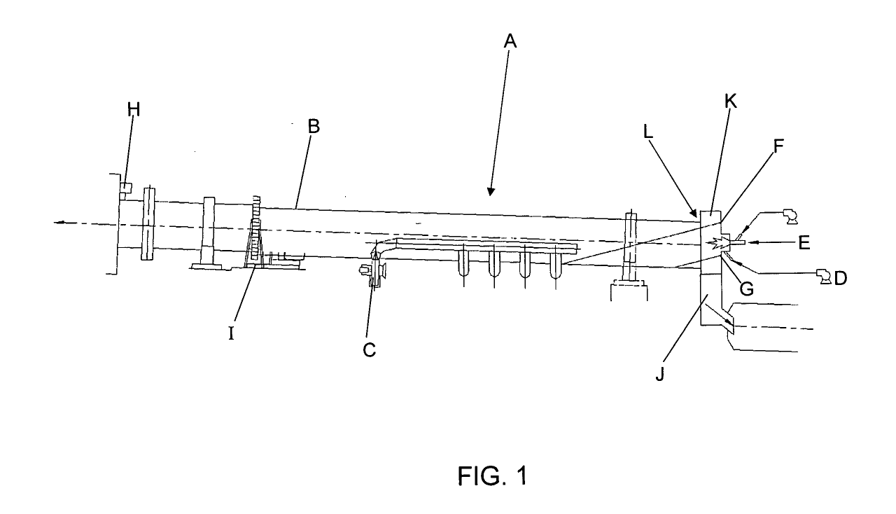

FIG. 1 provides an scheme of a typical furnace used for the calcination of oil cokes. The rotating furnace (A) comprises the following basic parts: rotating cylinder (B) horizontally mounted and internally refracted, having also a certain slope angle; air blowers (C), called tertiary air which is aimed at the injection of atmospheric air to the calcinating zone of the coke, where temperature varies from 1300 to 1400° C.; fans (D) mounted on the external zone of the furnace, close to the material discharge called head blowers, aimed at the cooling of the discharge head of the furnace; burner (E) mounted on the furnace discharge for use on the unit start-up or resuming; measuring system by optical pyrometry (F-G) of temperatures of the calcinating and discharging zones; thermocouple (H) for measuring the temperature of furnace gases outlet; and (I) drive system composed of crown, pinion, gearing and engine for providing the circular movement of the furnace or its cylindrical body (B), of which the lower end with the discharge breadth (J) constitutes the fixed part (K) and, between this and the cylindrical body (B) there is a clearance spot which should be sealed to avoid the entrance of leakage air (L) which endangers the process control.

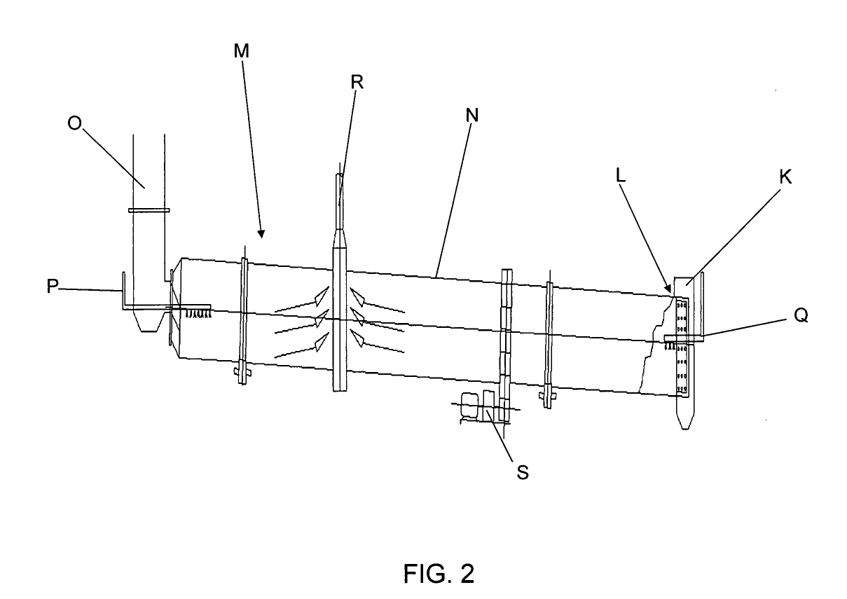

After the calcinating process, the coke is discharged through the discharge breadth (J) into a rotating cooler (M), schematically mounted in FIG. 2, where it can be seen that it has a rotating cylindrical body (N) which, through one end, has the product entrance (O) and the entrance of extinguishing water (P) and, through the other end, has also the entrance of water (Q), however for emergency, being that, along the cylindrical body there is also an unit of impounding of vapor air (R) and driving or rotating unit (S). Thus, by means of water jets, the calcinated coke temperature is lowered from 1100° C. to 110° C.; right after the cooling, the calcinated coke goes to the storage in silos and subsequent remittance to the aluminum market. The rotating cooler (M) also presents a fixed part (K) with a clearance spot or joint part (L) which should be sealed to avoid the entrance of leakage air endangering the process control.

In counterflow to the coke inside the calcinator there is a large gaseous mass, composed of several substances resulting from the cracking of volatile material in the green coke, humidity, dragged sharps and air injected inside the calcinator.

The release of humidity and heating of the coke takes place in the range of 25 to 400° C., and the devolatization takes place in the range of 500 to 1000° C.; the coke densification and burn of a small quantity of carbon takes place between 1200 and 1400° C.

The sharps dragged during the process are considered as a subproduct of low added value, and their generation and transport depend on several associated factors during the calcination.

As it has already been said, the most used conventional system for sealing of rotating furnace or cooler is the one composed of a fixed system which encircles the whole external part of the calcinating furnace in its ends, composed of metallic sustaining plates with oblong holes which were moved by traction against the wall of the calcinating furnace. This system, as already mentioned, is not efficient, not only because the sealing is not as efficient as wished, but also because it requires several maintenance interventions for the adjustment of the sealing.

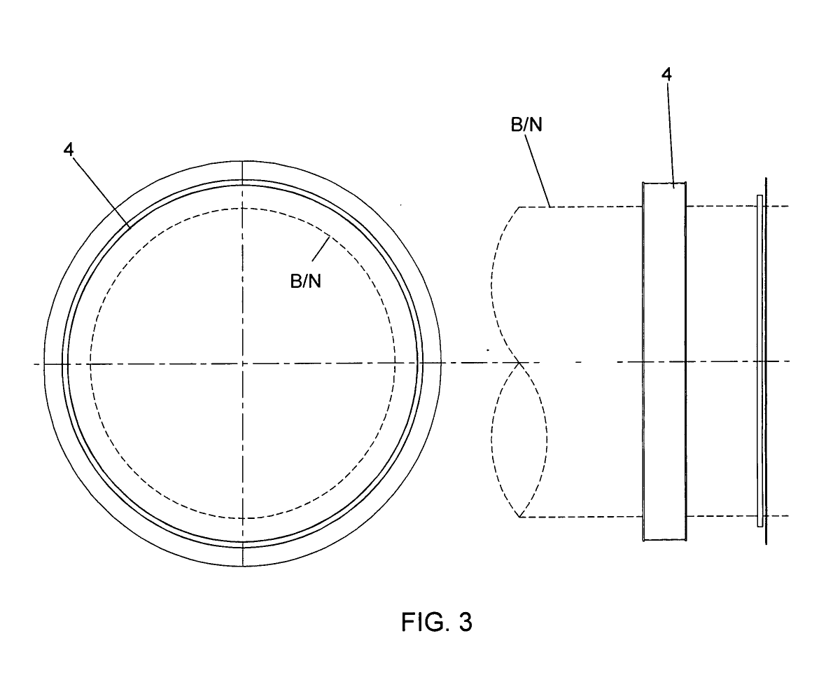

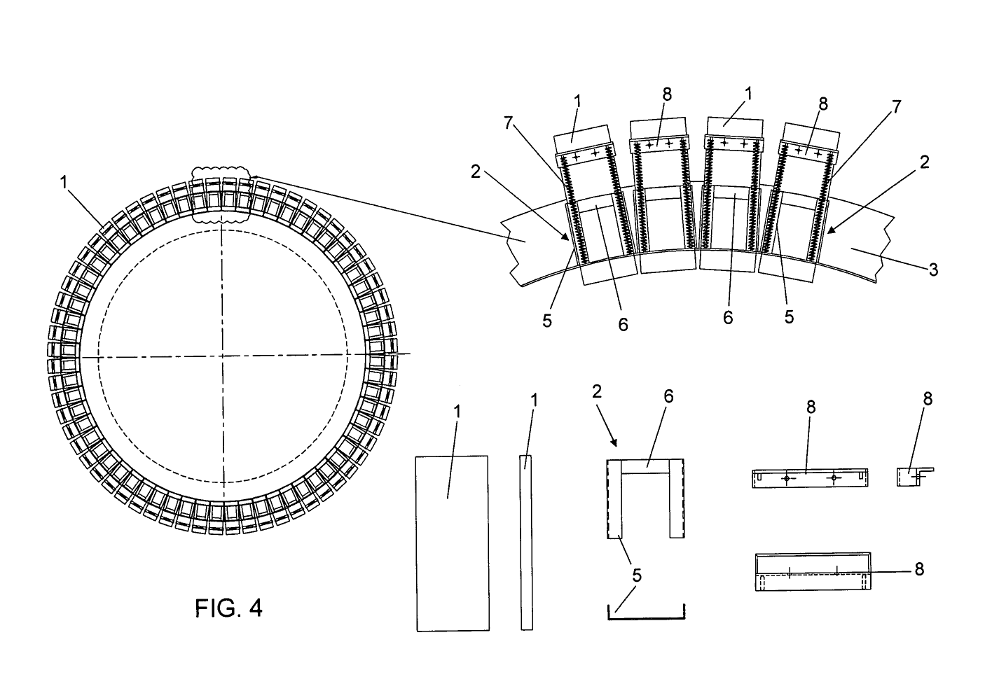

As per illustrated in FIGS. 3 and 4, this invention, the SEALING DEVICE FOR ROTATING FURNACE AND COOLER FOR CALCINATION OF OIL COKE, is characterized by the fact that it replaces the conventional system using several lead plates (1), ordinarily rectangular, all of them mounted in sliding form on individual supports (2) attached to a flange (3) which constitutes the fixed part of the furnace or cooler, where the said plates are aligned side by side, forming a collar of coplanar plates encircling the external diameter of the furnace or cooler, forming a self-adjustable sealing curtain between the joint point (L) of its rotating and fixed parts, while the referred cylindrical body (B or N) presents a track (4) against which all plates are held with a certain pressure; as a consequence, an excellent sealing is obtained between the rotating and fixed part of the set, both in the furnace and in the cooler.

In a preferred construction, each support (2) is defined by side angle bars (5) and a cross bar (6), forming a sliding fitting like a drawer for each lead plate (1).

In a preferred construction, each lead plate (1) is held in pressure by a pair of helical springs (7), one to each side, of which the ends are attached respectively to the lower part of the support (2) and to other support (8), the latter coupled to the end radially more distant from the lead plate (1), so that it can be held radially under pressure against the track (4) of the body diameter (B or N) of the furnace or cooler.

As it can be seen after what has been shown and illustrated, the lead plates (1) arranged as a collar ensure the forming of a sealing curtain of the joint point (L) formed between the rotating part and the fixed part of the furnace or the cooler. This curtain provides a better sealing of gaps between the mobile (rotating) part and the static part of the system, avoiding the entrance of leakage air and consequentially providing a better control of the process, including another additional advantage, since the lead, combined with the individual functioning form of each plate allows for an automatic adjustment compensating wears and superficial irregularities of the diameter of the furnace or cooler body, providing thus a much longer useful life to the set and significantly reducing the maintenance interventions.

It will be understood that certain characteristics and combinations of construction details of the furnace and the cooler may radically vary, maintaining the same functional concept for the two sets. Consequently, it can be observed that constructions detailed described for example for the furnace and the cooler, as well as for this sealing system of leakage air entrance, are clearly subject to constructive variations; however, always within the scope of the inventive concept hereunder of a sealing system in the shape of a collar defined by several lead plates placed radially and in handled form, and since many changes can be made to the layout detailed hereunder, according to the legal descriptive requirements, it is understood that present details should be interpreted as an illustrative and not exhausting form.

What is claimed is:

1. A sealing device in combination with a rotating furnace or cooler for calcination of oil coke, the rotating furnace or cooler having a fixed part formed by a flange and a rotating part with a cylindrical body, the sealing device comprising:
individual supports attached to the flange;
a plurality of rectangular lead plates slidingly mounted on said supports and arranged side-by side to form a collar of coplanar plates surrounding an external diameter of the furnace or cooler, wherein said plates form a self-adjustable sealing curtain between the rotating and fixed parts of the furnace or cooler, and
a track formed on the cylindrical body of the furnace or cooler, wherein all of said plates are held against said track with a pressure, for sealing a joint between between the rotating and fixed parts of the furnace or cooler.

2. The sealing device according to claim 1, wherein each support is formed by side angle bars and a cross bar, forming a sliding fitting for each lead plate.

3. The sealing device according to claim 1, wherein each lead plate is held under pressure by a pair of helical springs, one spring to each side of each plate, wherein ends of each spring are attached respectively to a lower part of the support and to another support, the other support being coupled to an end of the springs radially more distant from the track, so that the lead plate can be held radially under pressure of the springs against the track.
